(19) United States
(12) Patent Application Publication
(10) Pub. No.: US 2025/0056686 A1
(43) Pub. Date: Feb. 13, 2025

(54) MICROWAVE DEVICE WITH MICROWAVE TRAP

(71) Applicant: Miele & Cie. KG, Guetersloh (DE)

(72) Inventors: Joerg PFENDER, Gelsenkirchen (DE); Eckhard POEHLER, Versmold (DE); Timo BANGRAZI, Warendorf (DE)

(21) Appl. No.: 18/715,743

(22) PCT Filed: Nov. 15, 2022
(86) PCT No.: PCT/EP2022/082006

§ 371 Date: Jun. 3, 2024

(30) Foreign Application Priority Data
Dec. 9, 2021 (BE) BE 2021/5959

(51) Int. Cl. H05B 6/64

(52) U.S. Cl. CPC H05B 6/6473

(57) ABSTRACT

A microwave appliance includes: a treatment chamber bounded by a wall, the treatment chamber for receiving items to be treated; a microwave generator for exposing the treatment chamber to microwave radiation; and a fan for circulating air in the treatment chamber, the fan including a drive shaft extending into the treatment chamber through an opening in the wall, a disk-shaped fan impeller, a disk-shaped microwave trap body, and a microwave trap securely connected to the drive shaft on the treatment chamber side. The microwave trap forms an electrically conductive microwave trap wall that bounds a radially outwardly open cavity which is annular disk-shaped and oriented coaxially with the drive shaft. The disk-shaped microwave trap body is disposed on the drive shaft and positioned between the wall and the fan. The disk-shaped microwave trap body forms part of the microwave trap.

### CROSS-REFERENCE TO PRIOR APPLICATIONS

This application is a U.S. National Phase application under 35 U.S.C. § 371 of International Application No. PCT/EP2022/082006, filed on Nov. 15, 2022, and claims benefit to Belgian Patent Application No. BE 2021/5959, filed on Dec. 9, 2021. The International Application was published in German on Jun. 15, 2023 as WO/2023/104450 A1 under PCT Article 21(2).

### FIELD

The invention relates to a microwave appliance including a treatment chamber bounded by a wall, for receiving items to be treated, a microwave generator for exposing the treatment chamber to microwave radiation, and a fan for circulating air in the treatment chamber, the fan including a drive shaft extending into the treatment chamber through an opening in the wall, and a microwave trap securely connected to the drive shaft on the treatment chamber side.

### BACKGROUND

In such microwave appliances, the opening or pass-through hole formed in the microwave-tight wall for the drive shaft of an external drive motor is a critical leakage point through which microwave energy can escape from the treatment chamber or oven shell to the outside, which is undesirable. The prior art has described various types of microwave traps which are intended to prevent, to the extent possible, the escape of microwave energy at this point.

DE 28 34 368 A1, for example, describes a multi-part microwave bandstop filter which is composed of an axially parallel annular groove in the hub of the fan impeller, a microwave guide slot formed jointly by the fan impeller and the oven shell wall, and a disk mounted on the drive shaft outside of the oven shell. However, such a microwave trap takes up a lot of space and is complicated to manufacture due to its complex design. In addition, in the area of the guide slot, a substantial portion of the trap is formed by the oven shell wall and the back side of the fan impeller, which is only slightly spaced from the oven shell wall and rotates at high speed during operation. As a result, the functionality of this microwave trap is dependent on a perfectly concentric alignment of the drive shaft with the pass-through opening.

In contrast, DE 10 2018 214 098 A1 discloses a microwave trap concept where all parts of the trap are mounted on the drive shaft, which makes this trap less sensitive to a not perfectly concentric alignment of the drive shaft with the pass-through opening. The trap is composed of an antenna body which is arranged perpendicular to the drive shaft and has an effective diameter that corresponds substantially to the wavelength of the microwaves used. As a result, a standing microwave forms in the antenna body, the standing microwave having a minimum in the region of the drive shaft, which minimizes the leakage of microwave energy at this point. The antenna body may be formed by the fan impeller itself or by a disk mounted on the drive shaft. However, since in the case of common microwave frequencies in a frequency band around 2.45 GHz, the wavelength is about 12.2 cm, this microwave trap also takes up a lot of space. A slightly more compact design can only be achieved here by complex structural measures, such as a meandering curved shape of the end portions of the antenna body. In all embodiments, the microwave trap mounted on the drive shaft still has a high moment of inertia due its the design, so that a relatively large amount of energy must be provided for operating the fan.

### SUMMARY

In an embodiment, the present invention provides a microwave appliance, comprising: a treatment chamber bounded by a wall, the treatment chamber being configured to receive items to be treated: a microwave generator configured to expose the treatment chamber to microwave radiation; and a fan configured to circulate air in the treatment chamber, the fan including a drive shaft extending into the treatment chamber through an opening in the wall, the fan including a disk-shaped fan impeller and a disk-shaped microwave trap body forming part of a microwave trap securely connected to the drive shaft on the treatment chamber side, wherein the microwave trap forms an electrically conductive microwave trap wall that bounds a radially outwardly open cavity which is annular disk-shaped and oriented coaxially with the drive shaft, and wherein the disk-shaped microwave trap body is disposed on the drive shaft and positioned between the wall and the fan.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a sectional view of a portion of an exemplary embodiment of the inventive microwave appliance in the region of the fan;

FIG. 2 is a simplified view of the microwave trap according to FIG. 1, focusing on the components that make up the microwave trap:

FIG. 3 is a sectional view of the microwave trap, with electric field lines sketched in the cavity:

FIG. 4 is a sectional view taken along line I-I in FIG. 3, with magnetic field lines sketched in the cavity:

FIG. 5 shows graphs of zeroth-order Bessel functions for determining a suitable pair of diameters of the cavity:

FIG. 6 shows a family of graphs of differently weighted linear combinations of zeroth-order Bessel functions of the first and second kind for determining a suitable pair of diameters of the cavity:

FIG. 7 is a sectional view of a portion of another exemplary embodiment of the inventive microwave appliance in the region of the fan; and

FIG. 8 is a view of a further embodiment.

### DETAILED DESCRIPTION

In an embodiment, the present invention at least partially overcome the disadvantages of the prior art and to provide a particularly simple and easily implementable way to reliably prevent or reduce leakage of microwave energy in the region of the pass-through hole for the drive shaft.

In an embodiment, the present invention provides a microwave appliance including a treatment chamber bounded by a wall, for receiving items to be treated, a microwave generator for exposing the treatment chamber to microwave radiation, and a fan for circulating air in the treatment chamber, the fan including a drive shaft extending into the treatment chamber through an opening in the wall, and a microwave trap securely connected to the drive shaft on the treatment chamber side. The microwave appliance is characterized in that the microwave trap forms an electrically conductive microwave trap wall that bounds a radially outwardly open cavity which is substantially annular disk-shaped and oriented coaxially with the drive shaft. In the context of this invention, the cavity is substantially annular disk-shaped in particular when the opposite sides of the circular ring-shaped end faces bounding the cavity are substantially flat.

The design approach requires little space in the cooking chamber and changes the system only minimally, so that the hot air system absolutely corresponds to the state of the art of current household ovens and thus does not create a disadvantage to ovens without a microwave function.

The annular disk-shaped or cylindrical cavity can be characterized by way of an outer radius or outer diameter, an inner radius or inner diameter, and a height or thickness, the outer radius being many times larger than the thickness (preferably at least by a factor of 5, preferably at least by a factor of 7). In particular, the disk-shaped cavity features an open outer circumferential surface and an inner circumferential surface bounded by the microwave trap wall.

With a microwave trap configured in this way, it is possible to significantly reduce leakage of microwave energy in the region of the pass-through hole for the drive shaft. Since the microwave trap according to the invention is formed solely by components which are securely connected to the drive shaft, the operation of the microwave trap is not influenced by a (perfectly concentric) alignment of the drive shaft with the pass-through opening. In addition, it has been surprisingly found that this structural configuration makes it possible to produce a particularly compact microwave trap in a simple manner. In particular, an outer diameter of the microwave trap can be dimensioned to be significantly smaller than 12.2 cm, which corresponds to the microwave wavelength used in conventional appliances.

The annular disk-shaped cavity may be bounded, for example, by two disks, e.g., of metal, which are connected at their centers to the drive shaft, which in this embodiment is also metallic, the two disks being spaced from one another in the direction of the axis of rotation of the drive shaft. It is also conceivable to use disks of different diameters. In this case, the outer diameter of the cavity is defined by the outer diameter of the respective smaller disk. Also conceivable is an embodiment where the disk-shaped cavity is bounded by a disk and a non-disk-shaped body, the outer diameter of the cavity being defined by the outer diameter of the disk. The inner circumferential surface of the cavity may be bounded by the drive shaft, which thus forms part of the microwave trap wall. Alternatively or additionally, the inner circumferential surface of the cavity may also be bounded by another, in particular disk-shaped, body disposed on the drive shaft. In all of these variants, the bodies bounding the cavity may be composed of any suitable material, provided that at least their respective surface that bounds the cavity is electrically conductive (e.g., bodies made of a suitably coated ceramic or plastic material).

In accordance with one aspect, the annular disk-shaped cavity is bounded in the axial direction on one side by a disk-shaped main body of the fan impeller and on the other side by a disk-shaped microwave trap body. The main body is positioned such that it is spaced apart from the microwave trap body in the direction of the axis of rotation of the drive shaft. In particular, the main body is spaced from a wall bounding treatment chamber by a greater distance than the microwave trap body.

In accordance with an embodiment, the thickness of the annular disk-shaped cavity, which corresponds to the distance between the microwave trap body and main body, is many times smaller than half the outer diameter of the cavity, the outer diameter of the cavity corresponding in particular to the outer diameter of the microwave trap body.

One aspect is that the cavity or the microwave trap body has an outer diameter between 9 cm and 11 cm. As a result, the thickness of the cavity or the distance between the microwave trap body and the main body is smaller than 2 cm and, in particular, is in a range of from 0.1 to 1.3 cm.

In accordance with an embodiment, the distance of the microwave trap body from the wall bounding the treatment chamber is equal to or less than the thickness of the cavity or the distance between the microwave trap body and main body.

Another aspect is that the distance of the microwave trap body from the wall bounding the treatment chamber is less than 1 cm.

Examples of microwave appliances that may be considered include, in particular, microwave ovens and other cooking appliances with a microwave function, such as (baking) ovens and steam cookers where the treatment chamber is used to receive microwaves for the treatment of the items to be cooked. In this context, examples of suitable items to be treated are, in particular, food items that are cooked or thawed. The microwave oven typically has a front loading opening and a microwave-tight door by which the loading opening can be closed.

The microwave generator is designed particularly to expose the treatment chamber to microwaves of the frequency of 2.45 GHz or in a frequency band around this frequency. Preferably, the microwave generator includes a magnetron. The microwaves generated by it may, in particular, be guided into the treatment chamber by means of a microwave guide, e.g., a hollow waveguide. Preferably, in order to improve the field distribution, the microwaves guided into the treatment chamber may be distributed in the treatment chamber by means of guide elements, such as a reflector wing or a rotating antenna. In addition to the magnetron, semiconductor-based microwave generators are also conceivable.

The fan serves in particular to provide a forced-air convection or hot air function of the microwave appliance. The drive shaft of the fan may preferably be driven by a drive motor. In this case, the drive shaft is connected, preferably by a portion outside of the treatment chamber, to a drive motor, either directly or via a gear mechanism. The fan impeller may have one or more fan blades. The fan impeller may be slip-fitted onto the drive shaft. The fan impeller may be secured to the drive shaft by one or more nuts. The fan impeller may be disposed behind an air baffle plate.

In a preferred embodiment of the invention, the outer diameter of the is no greater than 10 cm, preferably no greater than 8 cm, particularly preferably no greater than 6 cm. Such a compact design of the microwave trap requires little space. In addition, in this way, it is possible to design a microwave trap having a low moment of inertia, thereby reducing the amount of energy required to operate the fan. Preferably, the thickness of the cavity measured along the axis of rotation of the drive shaft is 1 mm to 5 mm, preferably 1 mm to 3 mm.

In a further preferred embodiment of the invention, an inner diameter and an outer diameter of the cavity are dimensioned such that—in particular when the treatment chamber is exposed to microwaves—an electric field is approximately maximum at the outer diameter. The outer circumferential surface of the cavity thus serves as a type of high-impedance surface. The electric field is oriented parallel to the axis of rotation of the drive shaft (axial direction). In particular, in the context of this invention, an electric field is approximately maximum when it takes a value equal to no less than 90% of the nearest maximum. Surprisingly, it has been found that this type of structural configuration makes it possible to achieve a significant attenuation of the microwave energy leaking from the pass-through hole.

This is based on the following considerations: An electromagnetic wave enters the annular disk-shaped cavity in the region of its open outer circumferential surface, is reflected at the microwave trap wall in the region of the inner circumferential surface of the cavity, and then exits the cavity. Due to the reflection in the region of the inner circumferential surface, the electric field is always zero there. In contrast, a magnetic field whose field lines run in concentric circular paths around the drive shaft or its axis of rotation is maximum in this region. With increasing distance from the axis, the strength of the electric field increases, while the strength of the magnetic field decreases. If the outer diameter of the cavity is dimensioned such that the electric field is (approximately) maximum and the magnetic field is (approximately) minimum there, a type of high-impedance surface is created, at which at least a portion of the energy that would otherwise enter the cavity is reflected (impedance Z is equal to the quotient of electric field E and magnetic field H). For this purpose, it is only necessary to match the inner diameter and the outer diameter of the disk-shaped cavity. It has been found that by applying this novel microwave trap concept to current fan assemblies, it is possible to achieve much more compact designs than in the prior art.

One way of determining a suitable pair of diameters may be, for example, to solve wave equations in a cylindrical coordinate system using Bessel functions or cylinder functions. Given cylindrical symmetry, these functions can be used to describe the distribution of the electric and magnetic fields as a function of the distance from the axis of symmetry, i.e., of the respective radius. For this purpose, it is possible to use, for example, a suitable weighted linear combination of zeroth-order Bessel functions of the first and second kind. For a given inner radius of the cavity, it is possible to find a weighted linear combination of these Bessel functions that has a zero crossing at a point corresponding to the inner radius. Then, the outer radius may be selected to be a radius at which a maximum occurs in the function curve.

In order to achieve the most compact design possible with the smallest possible suitable outer radius or outer diameter, the first maximum that occurs after the zero crossing can always be used as a basis. Therefore, in a further preferred embodiment, an inner diameter and an outer diameter of the cavity correspond approximately (i.e., except for a tolerance of +10%, preferably +5%) to the following relation:

outer diameter=16+2.1*inner radius\hat{ }0.84+ln(inner radius),

where ln is the natural logarithm. In particular, at least the inner radius is selected from the range of 2 mm to 60 mm, preferably 2 mm to 20 mm, particularly preferably 3 mm to 10 mm.

In accordance with another preferred embodiment of the invention, a microwave trap that is particularly economical to manufacture can be achieved if at least one disk-shaped microwave trap body forms part of the microwave trap. The disk-shaped microwave trap body is in particular a metal disk. The microwave trap body may have a central hole. The microwave trap body may be slip-fitted onto the drive shaft or onto a sleeve surrounding the drive shaft. In particular, the microwave trap body is disposed between the fan impeller and the wall. The microwave trap may include, for example, two such disk-shaped microwave trap bodies which bound the annular disk-shaped cavity therebetween. The two microwave trap bodies may also have different outer diameters. In this case, the outer diameter of the cavity is defined by the outer diameter of the smaller disk-shaped microwave trap body.

In a further preferred embodiment of the invention, a fan impeller disposed, in particular, at one end of the drive shaft forms part of the microwave trap. By integrating the fan impeller, which is already on the drive shaft, into the microwave trap, there is no need to use separate parts, which makes it possible to achieve an even more compact design. In particular, at least a portion of a substantially flat back side of the fan impeller bounds the cavity toward the treatment chamber. A (back) side of the fan impeller is substantially flat if it is flat except for manufacturing tolerances and/or embossed stiffening features (e.g., in the form of ribs, knobs, etc.) For example, the annular disk-shaped cavity may be bounded by the fan impeller or its back side toward the treatment chamber and by a disk-shaped microwave trap body toward the wall.

Preferably, a disk-shaped spacer body is disposed between the microwave trap body and the fan impeller, which spacer body has a smaller outer diameter than the microwave trap body. The spacer body is in particular a metal disk. The spacer body may have a central hole. The spacer body may be slip-fitted onto the drive shaft or onto a sleeve surrounding the drive shaft. An outer circumferential surface of the spacer body bounds the inner circumferential surface of the annular disk-shaped cavity. Thus, the outer diameter of the spacer body corresponds to the inner diameter of the annular disk-shaped cavity. By using the spacer body, a defined distance can be ensured in the cavity between the two components bounding toward the wall and toward the treatment chamber in a structurally simple manner. In addition, in this way, the inner diameter of the cavity can be readily varied and, in particular, matched to the outer diameter of the cavity by the choice of the outer diameter of the spacer body.

In another preferred embodiment, the microwave trap includes the following components that are non-rotatably connected to the drive shaft, seen from the treatment chamber end of the drift shaft toward the opening or pass-through hole in the wall:
a fan impeller having a substantially flat back side bounding at least the annular disk-shaped cavity;
a metal disk serving as a spacer body and having an outer diameter defining the inner diameter of the annular disk-shaped cavity, and
a metal disk serving as a microwave trap body having an outer diameter defining the outer diameter of the annular disk-shaped cavity.

Although the configuration of the microwave trap according to the invention has been described in the preceding paragraphs on the basis of separate components (such as, for example, microwave trap body, fan impeller, spacer body), single-piece embodiments are also conceivable. In a preferred embodiment, the microwave trap body, the fan impeller, and the spacer body are formed as a single piece and slip-fitted onto the drive shaft.

Overall, the present invention presents a novel microwave filter concept that can be implemented with a small amount of space and is particularly easy to manufacture. Due to its pronounced compactness and simple design, the microwave trap according to the invention can be particularly easily combined with other trap concepts in order to further increase the filtering effect.

In another preferred embodiment of the invention, the microwave appliance has a plate-like cover on the wall, which plate-like cover has an in particular central passage through which the drive shaft extends, the cover and the wall together forming a can-shaped microwave bandstop filter. Surprisingly, it has been found that a filtering effect can be significantly increased by combing the microwave trap having an annular disk-shaped cavity with a can-shaped microwave bandstop filter. The plate-like cover can in principle be mounted on either side of the wall. Preferably, the plate-like cover is disposed on the side of the wall facing away from the fan impeller so as to take up as little space as possible within the treatment chamber.

An outer diameter of the can-shaped microwave bandstop filter is preferably 9 cm to 11 cm. Surprisingly, it has been found that a particularly good filtering effect can be achieved with a so-dimensioned cover in combination with the microwave trap having an annular disk-shaped cavity.

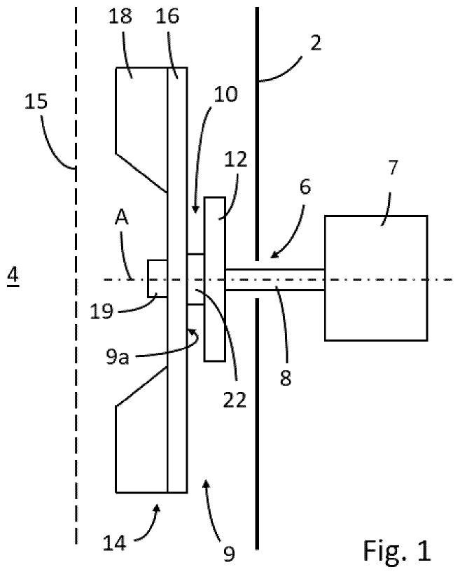

FIG. 1 shows a portion of a microwave appliance according to the invention, which has a treatment chamber 4 bounded by a wall 2, for receiving items to be treated. Treatment chamber 4 can be exposed to microwaves having a wavelength of, e.g., 12.2 cm. For this purpose, the microwave appliance is equipped with a microwave generator. The microwave appliance further has a fan for circulating air in treatment chamber 4. The fan includes a drive shaft 8 extending into treatment chamber 4 through an opening 6 in wall 2 and rotatable about an axis of rotation A, a fan impeller 14 disposed at one end of drive shaft 8, and a drive motor 7 connected to drive shaft 8 and capable of driving drive shaft 8. When viewed from treatment chamber 4, fan impeller 14 is disposed behind an air baffle plate 15, which serves to protect the fan from damage and contamination and to guide the air. In the present embodiment, fan impeller 14 includes a disk-shaped main body 16, from which a plurality of fan blades 18 extend.

A microwave trap 9 is disposed on drive shaft 8 on the treatment chamber side. Microwave trap 9 forms an electrically conductive microwave trap wall bounding an annular disk-shaped cavity 10. Cavity 10 is oriented coaxially with drive shaft 8 and is open toward the outside relative to axis of rotation A

Cavity 10 is bounded by fan impeller 14 toward treatment chamber 4 and by a disk-shaped microwave trap body 12 toward wall 2. Disposed between fan impeller 14 and microwave trap body 12 is a disk-shaped spacer body 22, whose outer circumferential surface bounds cavity 10 toward axis of rotation A and thus forms part of microwave trap wall 9a. The use of spacer body 22 has the advantage that a stable spacing of microwave trap body 12 and fan impeller 14 can be achieved in a simple manner, in particular without having to mount microwave trap body 12 and/or fan impeller 14 separately on drive shaft 8. To manufacture the embodiment shown here, microwave trap body 12, spacer body 22, and fan impeller 14 are successively slip-fitted onto drive shaft 8 and non-rotatably secured to drive shaft 8 by a nut 19 threaded onto the end thereof. In principle, however, spacer body 22 may also be dispensed with. In this case, drive shaft 8 itself bounds cavity 10 and forms part of microwave trap wall 9a. Also, a portion or all of the illustrated components that make up microwave trap 9 may be formed as a single piece.

In the present embodiment, fan impeller 14 includes a disk-shaped main body 16, from which a plurality of fan blades 18 extend. Fan impeller 14 may also be formed as a single piece. The back side of fan impeller 14 is substantially flat at least in a region opposite the microwave body 12, i.e., except for embossed stiffening features, such as ribs, knobs, etc., and forms part microwave trap wall 9a. At least the side of disk-shaped microwave trap body 12 facing cavity 10 is flat and forms part of microwave trap wall 9a.

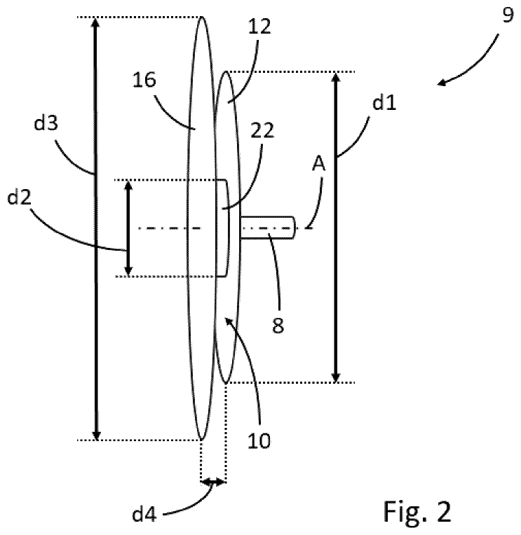

In this context, greatly simplified FIG. 2 illustrates the dimensions of cavity 10, as defined by the components that make up microwave trap 9. Outer diameter d3 of main body 16 of fan impeller 14 is larger than outer diameter d1 of microwave trap body 12. The cavity 10 bounded by these bodies therefore has the same outer diameter d1 as microwave trap body 12. Accordingly, inner diameter d2 of cavity 10 corresponds to outer diameter d2 of the spacer body. The annular disk shape of cavity 10 is characterized in that a thickness d4 is many times smaller than half the outer diameter d1 (=outer radius) of cavity 10.

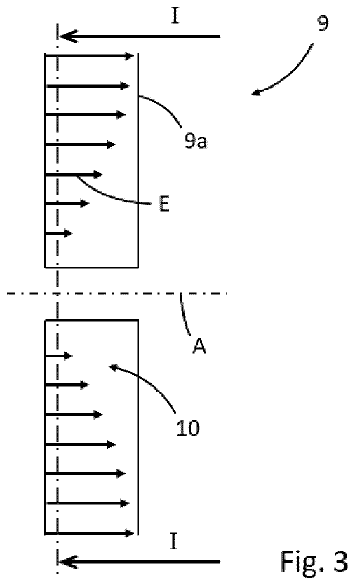

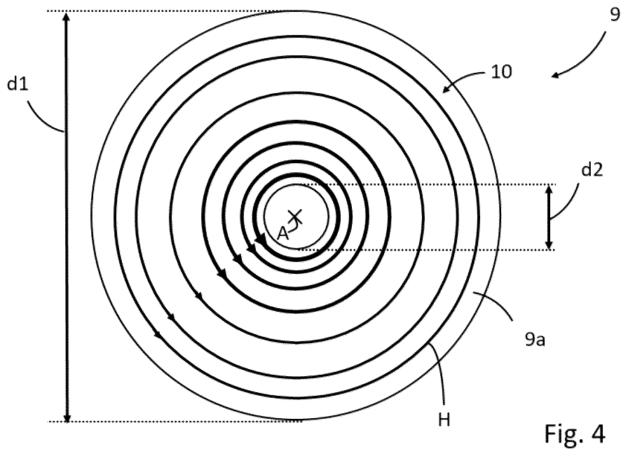

Referring to FIGS. 3 and 4, cavity 10 is designed with respect to its outer diameter d1 and its inner diameter d2 of cavity 10 such that when treatment chamber 4 is exposed to microwaves, an electric field E is approximately maximum at outer diameter d1. Electric field E is oriented parallel to axis of rotation A of the drive shaft (see FIG. 3), while the field lines of magnetic field H run in concentric circular paths around axis of rotation A. Since the electrical field is (approximately) maximum at outer diameter d1 of cavity 10, the magnetic field is (approximately) minimum. Thus, a type of high-impedance surface is created in the region of the outer circumferential surface of cavity 10, at which high-impedance surface at least a portion of the energy that would otherwise enter cavity 10 is reflected (impedance Z is equal to the quotient of electric field E and magnetic field H).

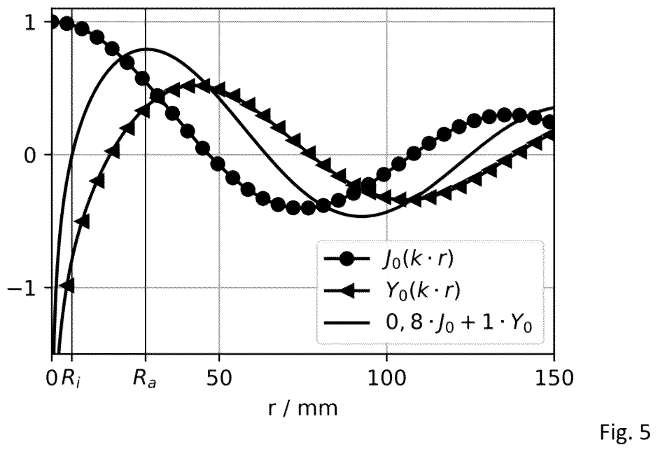

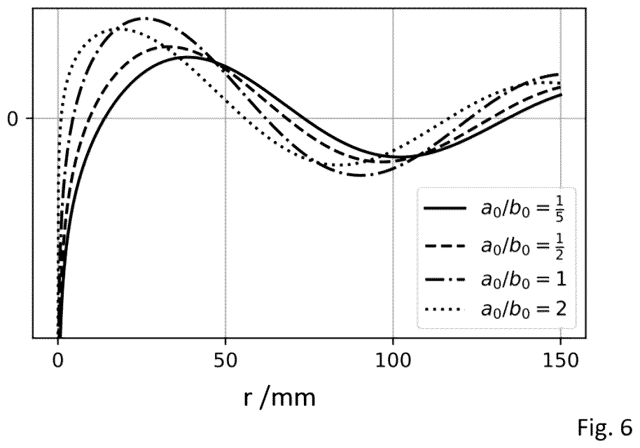

How a suitable pair of outer diameter d1 and inner diameter d2 may be determined is described below with reference to FIGS. 5 and 6. FIG. 5 shows values of zeroth-order Bessel functions (in arbitrary units) plotted against radius r in millimeters (mm). J0(k*r) is the Bessel function of the first kind, dependent on wave number k and radius r (see the line marked with dots), while Y0(k*r) is the Bessel function of the second kind, dependent on wave number k and radius r (see the line marked with triangles). Bessel functions can be used as solutions of wave equations in cylindrical coordinates and, therefore, are suitable for determining the zero crossing and the maximum of the electric field in cavity 10, which is annular disk-shaped and therefore has cylindrical symmetry. Since microwave trap wall 9a is conductive in the region of inner diameter d2, one boundary condition is that the electric field is zero at inner diameter Ri.

For a given inner radius Ri, a linear combination weighted with weighting factors a0 and b0

$$a 0 * J 0 ( k * r ) + b 0 * Y 0 ( k * r )$$

was selected, where a0 was set to 0.8 and b0 was set to 1 (see the line).

The resulting function curve has a zero crossing at the point Ri, so that the boundary condition is satisfied. An outer radius Ra suitable for forming microwave trap 9 can now be read from the point where the function has a maximum.

FIG. 6 shows a family of linear combinations as defined above, with different weighting factors a0 and b0, where the ratio of a0 to b0 is different in each case. It can be seen that by suitable selection of weighting factors, both the zero crossing and the maximum of the function curve can be varied and thus, for example, matched to a given inner radius Ri (point of the zero crossing) and/or outer radius (point of the in particular first maximum).

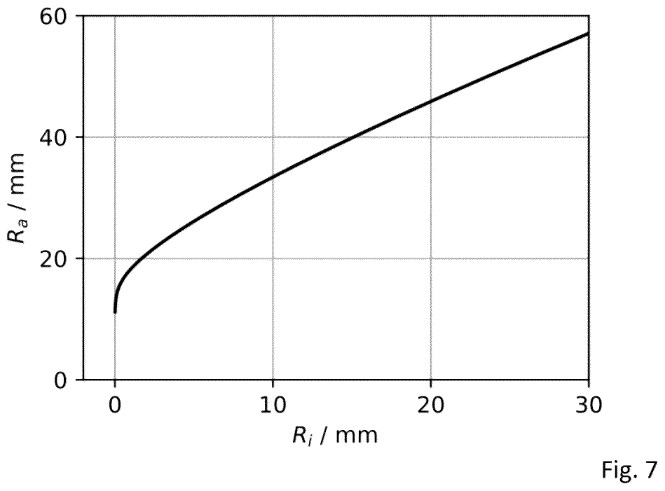

FIG. 7 shows a characteristic determined on the basis of the linear combinations described above, where inner radii Ri are correlated with outer radii Ra to form microwave trap 9. The characteristic corresponds to the relation

outer diameter=16+2.1*inner radius\hat{ }0.84+ln(inner radius),

where In is the natural logarithm. It has been found that outer radii Ra of less than 50 mm can be achieved in particular with easy-to-implement inner radii Ri of up to 20 mm. With inner radii Ri between 3 mm and 10 mm, it is even possible to achieve outer radii of less than 35 mm. Overall, using the concept presented here, it is possible to design much more compact microwave traps 9 than in the prior art.

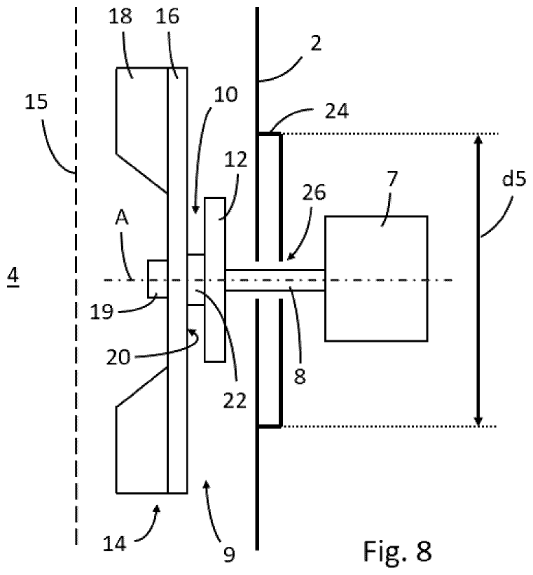

Due to the pronounced compactness of the microwave trap 9 presented here, this can be combined with further filter concepts without major design effort. FIG. 8 shows another embodiment of the invention, which is substantially similar to the embodiment of FIG. 1. The microwave appliance additionally includes a plate-like cover 24 having a central passage 26 through which drive shaft 8 extends. Cover 24 and wall 2 together form a can-shaped microwave bandstop filter. Outer diameter d5 of the can-shaped microwave bandstop filter is between 9 cm and 11 cm. Surprisingly, it has been found that a filtering effect can be significantly increased by combing the microwave trap 9 having an annular disk-shaped cavity 10 with a can-shaped microwave bandstop filter. Plate-like cover 24 can in principle be mounted on either side of wall 2. However, in order to take up as little space as possible within treatment chamber 4, plate-like cover 24 is preferably disposed on the side of wall 2 facing away from fan impeller 14.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A microwave appliance, comprising:
a treatment chamber bounded by a wall, the treatment chamber being configured to receive items to be treated;
a microwave generator configured to expose the treatment chamber to microwave radiation; and
a fan configured to circulate air in the treatment chamber,
the fan including a drive shaft extending into the treatment chamber through an opening in the wall, the fan including a disk-shaped fan impeller and a disk-shaped microwave trap body forming part of a microwave trap securely connected to the drive shaft on the treatment chamber side,
wherein
the microwave trap forms an electrically conductive microwave trap wall that bounds a radially outwardly open cavity which is annular disk-shaped and oriented coaxially with the drive shaft, and
wherein the disk-shaped microwave trap body is disposed on the drive shaft and positioned between the wall and the fan.

2: The microwave appliance of claim 1,
wherein an outer diameter of the cavity is 10 cm.

3: The microwave appliance of claim 1,
wherein an outer diameter of the cavity and an inner diameter of the cavity are dimensioned such that an electrical field is approximately maximum at the outer diameter.

4: The microwave appliance of claim 1,
wherein an outer diameter of the cavity and an inner diameter of the cavity correspond approximately to a following relation:
outer radius=16+2.1*inner radius\hat{ }0.84+ln(inner radius).

5: The microwave appliance of claim 1,
wherein the fan impeller is disposed at one end of the drive shaft.

6: The microwave appliance of claim 5,
wherein a disk-shaped spacer body is disposed between the microwave trap body and the fan impeller, which disk-shaped spacer body has a smaller outer diameter than the microwave trap body.

7: The microwave appliance of claim 1,
wherein the microwave appliance has a plate-like cover on the wall, which plate-like cover includes a central passage through which the drive shaft extends, the cover and the wall together forming a can-shaped microwave bandstop filter.

8: The microwave appliance of claim 7,
wherein an outer diameter of the can-shaped microwave bandstop filter is between 9 cm and 11 cm.

9: The microwave appliance of claim 2, wherein the outer diameter of the cavity is no greater than 8 cm.

10: The microwave appliance of claim 9, wherein the outer diameter of the cavity is no greater than 6 cm.
